(19) United States
(12) Patent Application Publication
(10) Pub. No.: US 2014/0256058 A1
(43) Pub. Date: Sep. 11, 2014

(54) SAMPLE TUBE WITH IMPROVED LID

(71) Applicant: VIBOD GMBH, Radebeul (DE)

(72) Inventor: Peter Dobrowolski, Radebeul (DE)

(21) Appl. No.: 14/351,072

(22) PCT Filed: Oct. 2, 2012
(86) PCT No.: PCT/EP2012/069455

§ 371 Date: Apr. 10, 2014

(30) Foreign Application Priority Data
Oct. 13, 2011 (EP) 11185055.8

(51) Int. Cl. B01L 3/14

(52) U.S. Cl. CPC B01L 3/14
USPC 436/174; 422/568; 422/569; 422/548; 422/550

(57) ABSTRACT

The present invention discloses a lid for a sample tube and a sample tube enabling ventilation or sealing depending on the closing position of the lid. Furthermore, a method for drying a sample and a use of the above lid or of the above sample tube for storing or drying a sample are subjects of the present invention.

### FIELD OF THE INVENTION

The present invention generally relates to containers and more particularly to sealable sample tubes.

### BACKGROUND OF THE INVENTION

Sample tubes of plastic material are widely used for collecting, storing and processing chemical or biological samples. Typically, sample tubes consist of a container which is linked by a lid hinge to a lid. The lid is sized and shaped to cover and seal the opening of the container when closed. The working volume is usually in the range of 0.2 and 5 ml.

Basically, the lid consists of three parts, lid top, plug and sealing lip, each having a different functionality. The lid top covers the opening of the container. The plug which is mostly cylindrical and hollow extends downwardly from said lid top and extends into the container of the sample tube when closed. The outer diameter of the cylindrical plug is slightly smaller than the inner diameter of the container, thereby enabling the fitting of the cylindrical plug into the container. The sealing lip is circumferentially attached around the bottom part of the cylindrical plug. The thickness of the sealing lip is usually sized to have a diameter slightly bigger than the inner diameter of the opening of the container, usually up to 0.1 mm, in order to frictionally seal the opening of the container when the lid is closed. Ideally, the seal is gas tight.

A gas tight seal, however, disables pressure compensation whenever a pressure difference between the inside and outside of a closed sample tube exists/is formed. A pressure difference occurs e.g. when the closed sample tube is heated or cooled or when the volume of the container is being mechanically compressed by closing the lid. The mechanical compression happens unavoidably since the sealing lip seals the opening of the sample tube as soon as the plug is inserted a few hundred μm into the opening. When the plug is further inserted into the opening of the sample tube, the interior volume is decreased until the lid top contacts the opening. The result is a pressure increase in the inside of the sample tube. In practice, the seal is rarely completely gas tight. In this case, the pressure difference is compensated over the time. The resulting disadvantage is that the above effect occurs also when the sample tube is being opened.

In almost any application, the above effect is undesirable. For example, it is often not possible to completely fill the container due to the small compressibility of liquids and the resulting high back pressure which is generated when the lid is being closed. Furthermore, a high pressure in the sample tube can lead to an unintended and uncontrolled opening of the lid, such as it is often observed when a closed sample tube is heated to between 60 and 100° C. The rise in temperature increases the vapour pressure of the gas phase in the sample tube until, above a certain threshold, the friction force of the lid is overcome and the lid opens. Exposure of the sample to the environment bears the risk that the sample is contaminated and that part or even the entire sample evaporates. Furthermore, microdrops of the sample are often catapulted out of the sample tube upon the sudden pressure compensation. It is obvious, that sample originating from an unintentionally opened sample tube must be carefully assessed with respect to volume, concentration and purity (contamination).

What is presently done to reduce the above risk is the securing of the lid against accidental opening by a number of means which vary in effectiveness, including friction force-fit of the lid in the tube, integrated lid “catches” which secure the lid (or secure a lid over-cover) to a lip flange provided on the tube, or alternatively, by separate lid clamps which may be slid or snapped into place after the lid has been closed. Examples of such tubes are the safe lock sample tube by Eppendorf having a claw fastener at the front of the lid and the sample tube by Biozyme which mechanically blocks the opening of the lid with a spherical element. However, if the seal is very secure, it is relatively difficult to open and close the tube, requiring both hands.

What can be also done is to reduce the pressure difference which occurs when the lid is being closed or opened which can be achieved by lids having plugs of a smaller length and/or lids having a sealing lip which is positioned not at the bottom but close to the top of the plug. Although the above pressure effect is not severe, it was found that such sample tubes suffer from unintentional opening of the lid due to a lower friction. Accordingly, a short length of the plug is desirable for reducing the pressure change during closing or opening the lid and a long length of the plug is desired to secure the lid during heating of the sample tube. Hence, such sample tubes do not completely overcome the above disadvantages.

Biozyme offers a smooth-running lid for 0.5 ml PCR sample tubes which has a higher head space above the filling volume of the sample (e.g. Chimney Lids, Domed Caps). Due to the high compressibility of the gas phase of the head space the resulting pressure difference upon closing or opening the sample tube is smaller than without a head space. However, a high gas phase volume expands strongly under heat.

Another problem in this context is that the force for opening and closing conventional sample tubes is highly dependent on the filling volume since the compressibility of liquid is much smaller than of gas. There are many applications where it is desired that the lid of the sample tube can be closed with the same force independent of the filling volume, e.g. robotic applications. Suitable sample tubes in this context are not available at present.

Furthermore, sample tubes are frequently used for long-ten i storage of biological or chemical samples. Particularly, the number of DNA and RNA samples increased rapidly over the last 15 years. In some applications, such as forensic science, the samples need to be stored over many years in order to enable potential follow-up examinations until the decision of a court has become effective. The samples are therefore usually frozen and stored at −20° C. or −80° C. However, freezing capacities are limited. Therefore, alternative and cheap methods for sterile drying and storing samples at room temperature are required.

Known methods comprise the lyophilisation of frozen samples and the drying of the sample at room temperature by solely exposing it to the air. This can be easily enabled by opening the lid of the sample tube. However, the integrity of the DNA cannot be guaranteed. The addition of sugars such as trehalose may stabilize DNA, proteins and membranes during dehydration. Furthermore, synthetically derived substances, e.g. QIAsafe™ DNA of Qiagen, SmapleMatrix™ of Biometrica Inc., and GenTegra™ of Genvault enable mild drying and rapid rehydration of DNA samples.

As a common feature of the above methods an evaporation step is performed. To enable evaporation, the lid of the sample tube is opened and kept open until the sample is dried. However, this bears the risk that the sample gets contaminated by particles present in the air. This is particular risky if several samples nearby are dried at the same time. The contamination of samples by foreign DNA is to be strictly avoided in forensic applications. Due to the high sensitivity of PCR methods, even small contamination of a sample with foreign DNA is detectable. If the sample tubes are not to be placed under a hood, said risk can be reduced by covering the opening of the sample tubes, for example with a sheet of paper. Due to the lack of a viable solution forensic samples are not stored at room temperature in a dried state.

Reaction tubes, which may be centrifuged, are well known in the art (for example Eppendorf tubes). In such cases the lid is connected to the container. Typically, the connection is done by means of a small plastic fillet. The container, the lid and the fillet are made of the same material. Typically this is polyethylene or polypropylene. The reason for the success of these a tubes is, that such a tube may be opened with only one hand. The other hand may be used for pipetting a liquid into said tube if said tube is open. As a consequence, when closing the lid, the lid is brought towards the container at an angle of 20° to 40° when it faces the top of the lid. Consequently, the diameter from the part of the lid that enters into the container must be in all portions smaller than the diameter of the container portion taking up the lid portion. As a consequence, the lid typically has a circumferential sealing lip. The sealing lip is typically positioned around the plug extending downwardly from the total lid. Other means of tightly closing containers may be found in the following patents or patent applications, JP 2001-206397, U.S. Pat. No. 3,164,279, U.S. Pat. No. 4,227,620 as well as WO 2007035746 A2. At the same time the plug which extends from the lid into the container ideally may not be in contact with the liquid contained in the container. The ordinary sealing lip will not allow for any transfer of gas from the container to the outside of the tube, when the person using the tube closes the lid. This leads to a higher pressure in the tube which may lead to a distribution of the liquid contained in the tube throughout the closing process, i.e. contamination of the sample in the tube. At the same time if the sealing lip is incomplete, i.e. there is a space where air or liquid may leave the container, the container is logically in itself not completely air and liquid tight. Such non tight closure may be found in the following patents or patent application, U.S. Pat. No. 3,025,991, U.S. Pat. No. 3,881,626, WO 2007035746 A2 (see FIG. 15 therein) and WO 2012016720 A1 (see holes above the sealing lip).

Hence, it is desired to have a sample tube which is easily to handle and enables a secure seal. It is desired to have a sample tube which enables the opening and closing without loss of sample and with a lower risk of contamination than the existing ones. It is further desired to have a sample tube which enables the drying of the sample with no or a lower risk of contamination than the existing ones.

However, the present invention has solved the problem of providing for an air and liquid tight container as well as permitting air to be released from the container when the lid is closed with the plug entering the container. This insures that no splattering, splashing or otherwise contamination of the sample contained in the container occurs.

### DESCRIPTION OF THE INVENTION

The problem is solved by the present invention through the provision of a lid for a sample tube comprising a lid top, a plug extending downwardly from said lip top, and a circumferential sealing lip around said plug, wherein the sealing lip is sized and shaped to positively fit into the opening of a container of the sample tube, wherein the sealing lip is sized and shaped to seal the container when the lid is fully closed and wherein the sealing lip and/or the plug is configured to enable gas or liquid transport between the inside and the outside of the container when the lid is partially closed.

Further encompassed by the present invention is a sample tube comprising a container having an opening and the above lid.

Further encompassed by the present invention is a closure for a sample tube comprising an insert having a top opening and a bottom opening, and a circumferential sealing lip around said insert, wherein the sealing lip is sized and shaped to positively fit into the opening of a container of the sample tube, wherein the sealing lip and/or the insert is sized and shaped to seal between insert and container when the closure is fully plugged in and wherein the sealing lip and/or the insert is configured to enable gas or liquid transport between the inside and the outside of the container when the closure is partially plugged in.

Further encompassed by the present invention is a sample tube comprising a container having an opening and the above closure.

Further encompassed by the present invention is a container for a sample tube having an opening at one end, wherein the container is configured to enable gas or liquid transport between the inside and the outside of the container when the sample tube is partially closed and wherein the container is sized and shaped to seal the sample tube when the insert is fully closed.

Further encompassed by the present invention is a method for drying a sample comprising the steps of providing the above lid and a container having an opening, or the above sample tube, or the above closure or the above container, placing the lid/closure onto the opening of the container of the sample tube into partially closed position which enables gas transport between the inside and the outside, and incubating the sample for appropriate time and under appropriate conditions.

Further encompassed by the present invention is the use of the above lid or of the above sample tube, or the above closure or the above container for storing or drying a sample.

### FIGURE LEGEND

The following Figures are enclosed herein to exemplify preferred embodiments of the present invention. They shall in no way be interpreted as narrowing the scope of the present invention.

FIG. 1: Preferred embodiment of the sample tube according to the invention. The sample tube comprises a lid, a flexible lid hinge (2) and a container (1) having an opening at one end (10). The lid consists of a lid top (3), a plug (4) and a circumferential sealing lip (5) around said plug. A part of the sealing lip is deformed and extends towards, in this particular embodiment contacts the top of the lid (7), leaving a gap (8) on the surface of the plug. This gap is open towards the outside of the container, thereby enabling gas transport during the opening and closing operation and when the lid is partially closed. When the lid is fully closed the gap is sealed towards the outside by contacting the inner wall surface of the container. An integral lid extension (9), often called lifting tab, located on the edge opposite to the lid hinge aids in unseating and opening.

FIG. 2: Cross section of the closed sample tube shown in FIG. 1.

FIG. 3: Another preferred embodiment of the inventive sample tube. This sample tube has additionally an opening of the plug (18) which corresponds to the deformed part of the sealing lip.

FIG. 4: This embodiment shows a less developed deformation of the sealing lip (17) and a corresponding opening of the plug (28).

FIG. 5: Various configurations of the sealing lip and/or the plug which allow ventilation in partially closed position. All lids consist of a lid top (3), a plug (4), a sealing lip (5) and a configuration (8). The configuration is a (A and B) deformation, (C) constriction, (D) opening, (E and F) recess of the sealing lip. B has additionally a recession of the plug (8′). F shows a further sealing lip (5′) above the lower sealing lip (5) which prevents from leakage. G and H show lids having an unmodified (no configured) sealing lip (5). Here, the configuration is an opening in the plug above the sealing lip. A further sealing lip (5′) around (G) or above (H) the opening ensures tights sealing.

FIG. 6: Ventilation mechanism of the inventive lid. A: open sample tube; B: partially closed sample tube enabling ventilation; C: fully closed and sealed sample tube.

FIG. 7: Ventilation mechanism of the inventive container. A: open sample tube; B: partially closed sample tube enabling ventilation; C: fully closed and sealed sample tube.

FIG. 8: Lid-in-lid closure. The closure comprises an insert (4), a lid and a lid hinge (12). A sealing lip of the insert (5) is located around the plug of the insert (4). The sealing lip is configured (7) to allow ventilation when the closure is plugged into a sample tube in partially closed position. When the insert is completely plugged into a container (1) (i.e. fully closed), the sealing lip effectively seals between insert and container. A conventional lid having an unconfigured annular sealing lip (15) around its plug (14) is attached to the insert via a lid hinge (12).

FIG. 9: Further embodiments of the sample tube. The sealing is in this case preferably enabled via lid top and opening of the container.

FIG. 10: The prior art tubes show disadvantages when it comes to closing the tube. A shows a lid type without extra lip. B and C shows a similar problem with a lid with lip.

### DETAILED DESCRIPTION OF THE INVENTION

It is an object of the present invention to provide a sample tube which is simple and economical to manufacture.

It is a further object of the present invention to provide a sample tube that can provide a sufficiently tight seal so that the material can be handled in a stressful manner, i.e. when being boiled, frozen, or shipped. Ideally, the sample tube has a lid which is connected via a junction or hinge with the container.

It is another object of the present invention to provide a tube that can be easily opened and closed with one hand without loss of sample.

It is yet another object of the present invention to provide a tube that can be used for drying the sample at room temperature without getting contaminated.

The present invention does meet the desired criteria. For example, when a closed sample tube is heated the inventor observed that the accidental opening of the inventive lid occurs less frequent than of a conventional lid. The inventive lid is lifted from the closed position into a so-called partially closed position. In the partially closed position the lid still covers the opening of the container, thereby preventing from contamination. Furthermore, in the partially closed position only a small gap is present. Hence, evaporation is significantly decreased in comparison to a conventional lid. Due to a ventilation mechanism described below the closing and opening force is less dependent on the filling volume which is particularly useful for automatic handling. Furthermore, the gap offers the introduction of a sensor into the sample tube while the lid is in partially closed position. These advantages are achieved by the following invention.

The present invention relates to the provision of a lid for a sample tube comprising a lid top, a plug extending downwardly from said lip top, and a circumferential sealing lip around said plug, wherein the sealing lip is sized and shaped to positively fit into the opening of a container of the sample tube, wherein the sealing lip is sized and shaped to seal the container when the lid is fully closed and wherein the sealing lip and/or the plug is configured to enable gas or liquid transport between the inside and the outside of the container when the lid is partially closed. Alternatively or additionally to a sealing lip, sealing is achieved via the lid top. The lid is ideally connected to a container.

Accordingly, the present invention provides a lid for a sample tube that is capable of sealing tightly and enables ventilation depending on the closing position of the lid. The lid enables a consistent flow of air out of the container when the lid is being closed and a flow of air into the container when the lid is being opened, thereby compensating the undesired pressure increase or pressure decrease and preventing the above problems. When the lid is fully closed the sample tube is tightly sealed and leakage prevented.

“Up/top” and “down/bottom” herein refers to the respective positions of the sample tube or the lid when viewed at an upright closed tube.

Herein, three positions of the lid are used: “fully closed”, “partially closed” and “open”. The terms fully closed and partially closed describe two closing positions. Fully closed means any position wherein the lid circumferentially contacts the opening and/or the inner wall surface of the container over the whole perimeter such that no air gap is present between the lid and the container. This is preferably accomplished by a circumferential uninterrupted contact of the sealing lip and the container. In certain embodiments this term also describes a position wherein the sealing is achieved via the contact of the lid top and the opening of the container over its whole perimeter. Ventilation is not enabled in this position by definition.

Partially closed refers to a position wherein the lid is plugged into the opening of the container such that the configured part of the sealing lip and/or of the plug forms an air gap between the lid and the container, thereby allowing ventilation of the sample tube. Partially closed can be understood as a penetration depth of the plug of a certain distance. Depending on the length of the plug and the position of the configuration this distance starts at a penetration depth of 0.5, preferably 1.0, more preferably 1.5, more preferably 2.0 mm and ends 0.5, preferably 1.0, more preferably 1.5, more preferably 2.0 mm before the maximum penetration depth. It is to be noted that this term does not describe a position wherein the lid is loosely placed on top of the opening such that ventilation occurs through a remaining slid between lid and container. Accordingly, a constructional designed configuration leaving a gap in partially closed position according to the present invention is to be distinguished from an artificially created slid which can be created by conventional sample tubes. The terms “fully plugged in” and “partly plugged in” are used in the context of the inventive closure (a so-called lid in lid) and have the corresponding meaning to the above terms used in context of the inventive lid. In the case of lids that are attached to the container with a hinge, such as for a microcentrifuge tube partially closed means that the lid is pressed onto the container at a certain angle, i.e. between 20-40°.

The invention hence, preferably also relates to a sample tube comprising

(a) a container having an opening and

(b) a lid according to any one of the claims 1 to 4 or a closure according to any one of the claims 4 to 9,

(c) a lid hinge linking container and lid, wherein the sample tube is a microcentrifuge tube with a volume between about 100 microliters and 2 ml and, wherein when the lid is partially closed it rests at an angle of between 20-40° with respect to the container.

In contrast to the above, open herein means that the plug does not penetrate into the opening of the container.

A “configuration” herein means any constructional design, wherein an air gap exists in partially closed position, thereby enabling ventilation of the inside of the sample tube. A configuration can be present at the plug or at the sealing lip or at both the plug and the sealing lip. Preferably, the configuration is a deformation, constriction, recess or opening of a part of the sealing lip and/or a recess or opening of the plug. A configuration in the meaning of the invention can have different sizes, shapes and positions depending on the intended use. For example, a large configured area is desirable if high ventilation is to be achieved. Also, a configuration extending up to the top of the lid is useful. This shape effectively minimizes the pressure difference during closing and opening. If it is desired to intensify ventilation, both the plug and the sealing lip are configured, wherein the configured part of the sealing lip corresponds to the configured part of the plug in size, shape and/or position. Furthermore, ventilation is also increased by a hollow plug which is open towards the bottom of the lid. Also, “configuration” encompasses that the lid is attached to the container with a junction or hinge, i.e. preferably a thin plastic attachment.

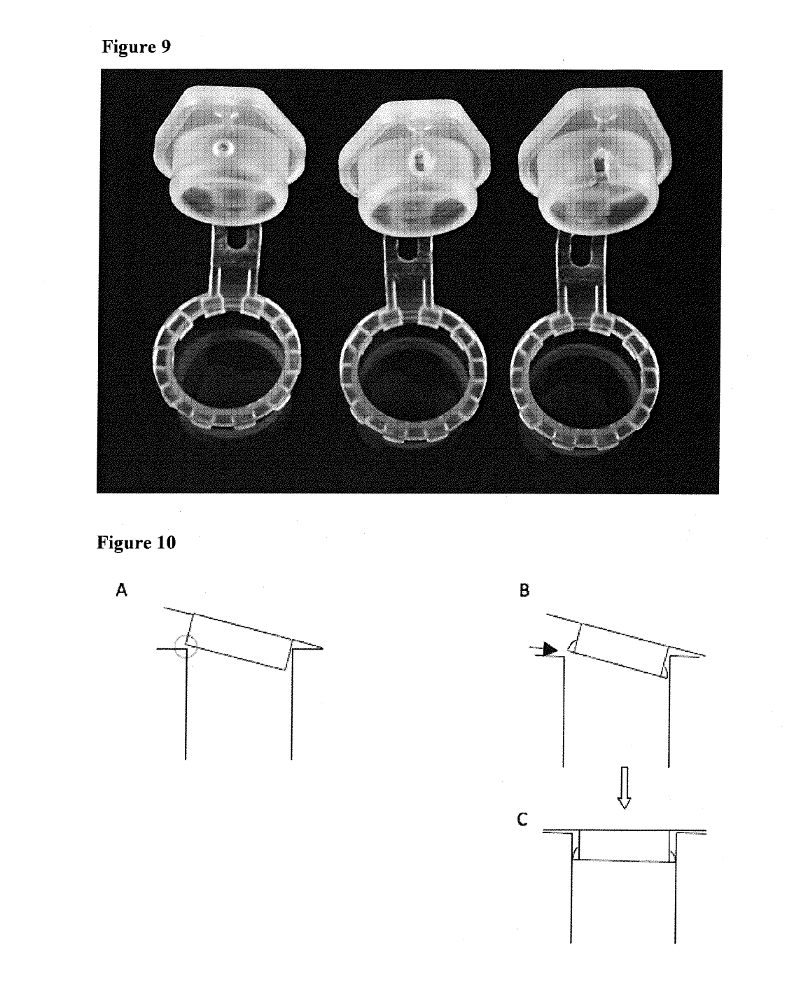

As shown in FIGS. 9 and 5E, the lid comprises a circumferential sealing lip comprising at least one interruption through which the air can exhaust while the lid is closed. The interruption may have different forms. In one embodiment the interruption is an essentially round opening. In another embodiment the interruption is an oval opening. The opening can for example be located at the plug or at the sealing lip. In yet another embodiment the interruption is a vertical cut within the sealing lip. However, it is preferred that a tight sealing between the top lid and the opening of the container is ensured if the sample tube is to be handled in a stressful manner.

Since such sealing is difficult to achieve, the following embodiments differ in that they are designed to enable tight and secure sealing via a sealing lip even if handled in a stressful manner.

For example, this can be achieved by a further sealing lip above the recessed one (FIG. 5F).

FIGS. 5G and 5H show an opening of the plug above a sealing lip being not configured. A further sealing lip around or above the opening of the plug enables tight sealing of the fully closed lid. Accordingly, in one embodiment of the invention a recess or opening of the plug is located above the sealing lip, wherein a further positive fitting sealing lip encircles said recess or opening and wherein the sealing lip has no recess.

Preferably, the sealing lip is not completely interrupted. A constriction or opening of the sealing lip as shown in FIGS. 5C and 5D provides an efficient sealing, while enabling good ventilation. Being obvious to the skilled person, the opening of the sealing lip requires an opening of the plug at its corresponding position to enable ventilation.

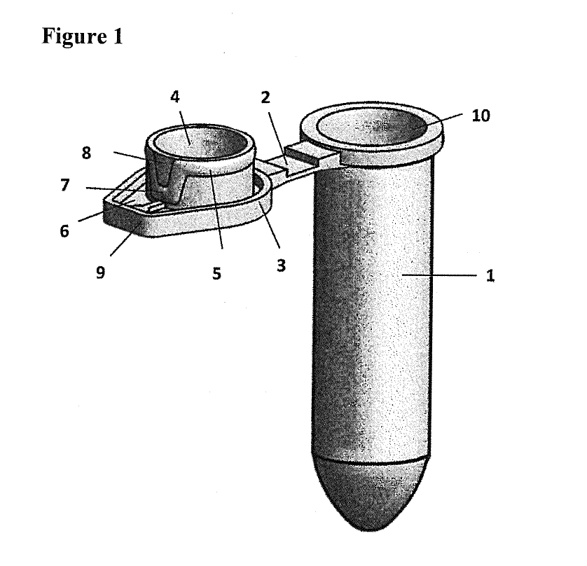

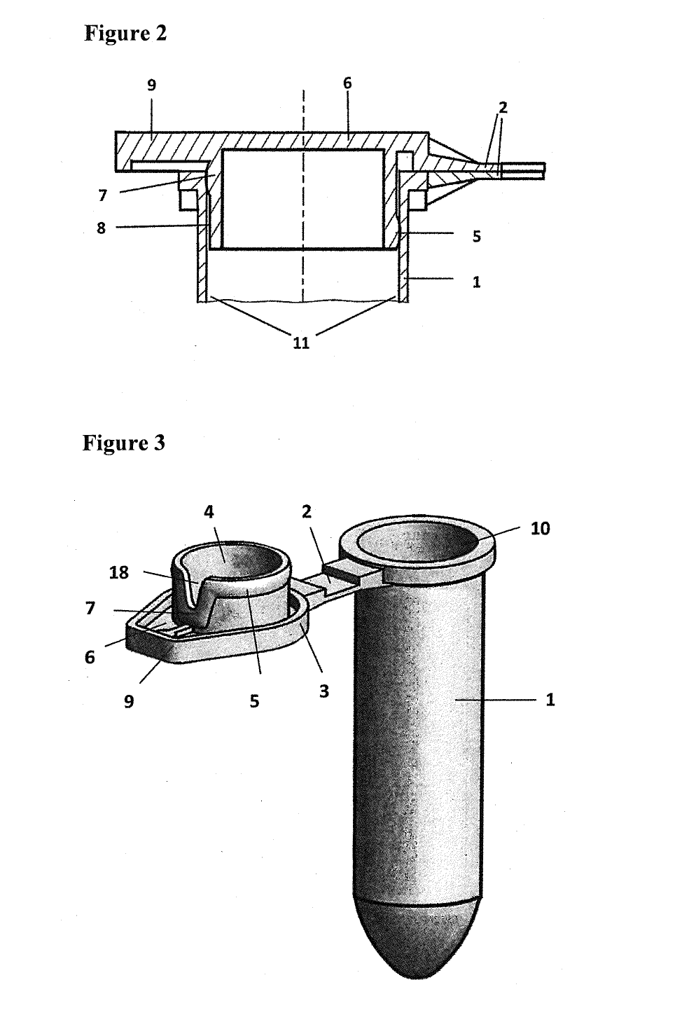

Most preferably, the sealing lip has a deformation towards the top of the lid (FIGS. 1 to 4, 5A and 5B). As a result a gap is formed on the surface of the plug extending towards the bottom of the lid. A recess of the plug at the corresponding position as the deformation of the sealing lip increases ventilation (FIGS. 3, 4 and 5B).

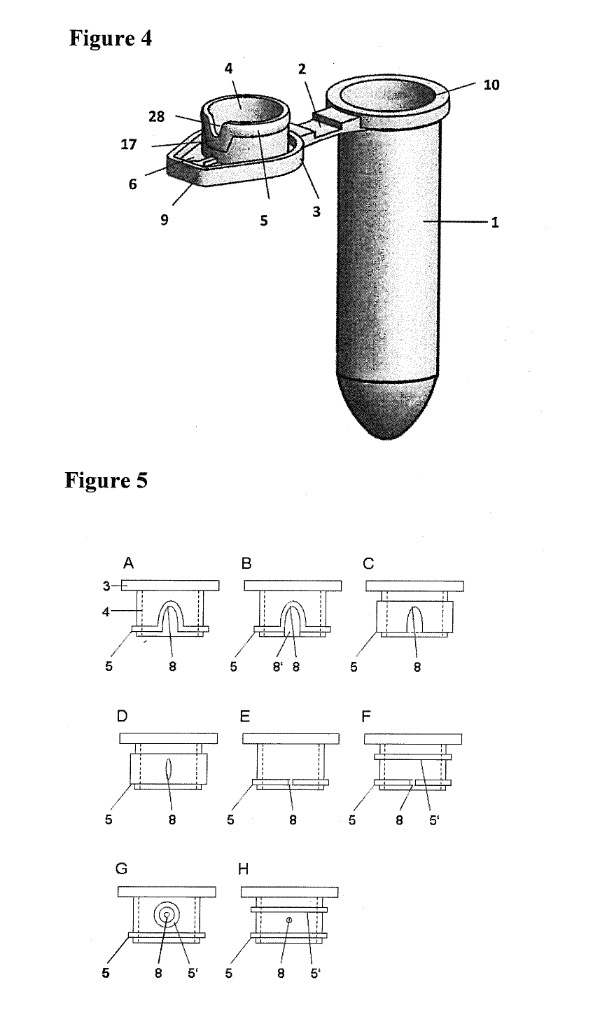

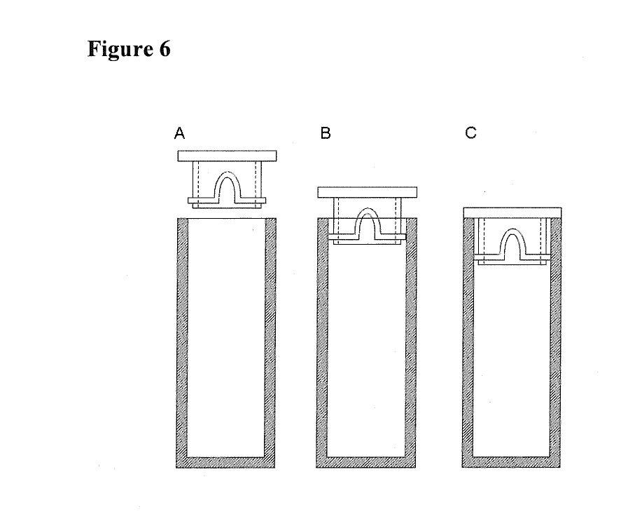

Preferably, the deformed or constricted part of the sealing lip extends towards the top of the lid. As described above, the deformed part extends over a part of the length (FIG. 4) or over the full length (FIG. 3) of the sealing lip depending on the intended use.

Preferably, the deformed or constricted part of the sealing lip is U- or V-shaped.

The skilled person will readily appreciate the advantages and disadvantage of the above embodiments. For example, a recessed sealing lip or an opening of the plug above the sealing lip is easy to manufacture. However, if a tight sealing between the lid top and the opening is not achieved, leakage and evaporation of the sample or penetration of contaminants and water can occur. A further sealing lip around the sealing lip or around the plug located above the opening may overcome said disadvantage.

In one embodiment a resistance, e.g. an elevation of the plug or sealing lip, locks the lid into a partially closed position. This is particular useful in order to increase the reproducibility of drying a sample using a partially closed sample tube.

In a preferred embodiment the lid has at least one integral lid extension suitably configured and arranged on the edge of the lid so that mechanical pressure applied to the underside of the lid extension unseats and moves the lid from the sealed container.

In a further embodiment, the lid further comprises a filter sized and shaped to block the penetration of contaminants through the recess of the sealing lip and/or the plug. Preferably, the plug is hollow and the filter is placed into the hollow plug. Alternatively or additionally, a shield extends downwardly from the top of the lid to block the penetration of contaminants through the recess of the sealing lip and/or the plug. A shield can be achieved by a prolongation of the lid top and curvature to cover the air gap which is formed in partially closed position. An example of this construction is the Shield Tube of Biozyme. Said embodiments are even safer with respect to contamination and particularly useful for drying a sample in a partially closed sample tube.

The present invention also embraces a plurality of lids being connected to each other in a pattern to allow the closure of a strip of sample tubes or a plate of sample tubes. The pattern preferably consists of 1 or more by 8 or more, preferably 1 by 8 or 12 by 1 or 12 by 8. Most preferred are flexible strips of 8 or 12 lids designed to fit in the opening of a row or a line of a conventional 96-well plate. Also preferred is a flexible plate of 8 by 12 lids designed to fit in the opening of a conventional 96-well plate.

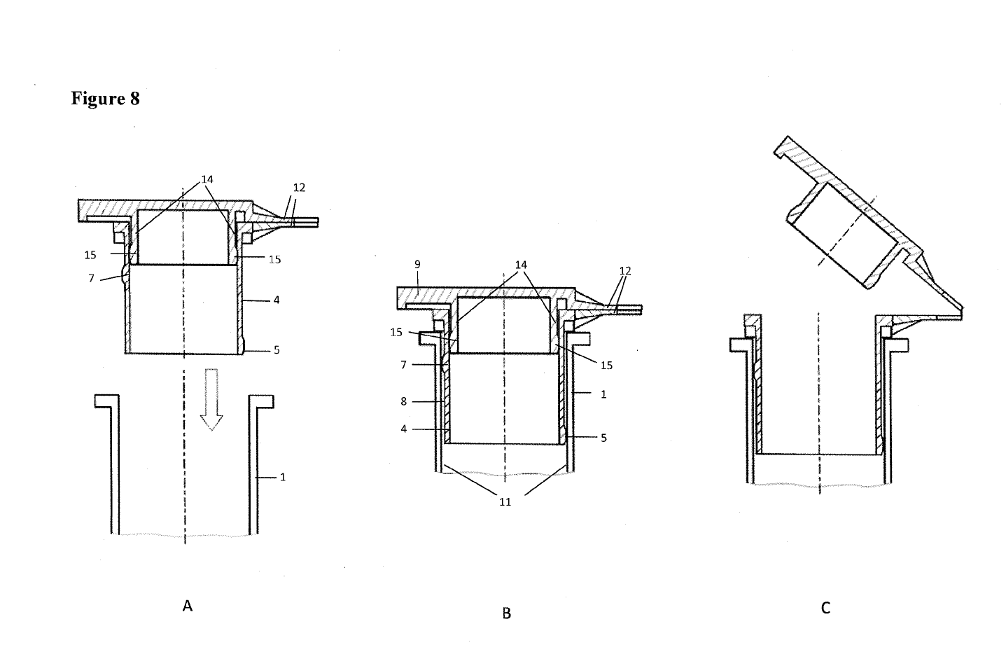

What is also comprised by the present invention is a lid-in-lid for a sample tube as exemplified in FIG. 8. The lid-in-lid comprises a lid and an insert having a top and a bottom opening. The lid is conventionally designed, i.e. has a sealing lip which is sized and shaped to positively fit into the top opening of the insert and which is sized and shaped to seal between the insert and the lid when the lid is closed. The insert has a sealing lip which is sized and shaped to positively fit into the opening of a container of the sample tube, which is sized and shaped to seal between the insert and the container of the sample tube when the insert is fully closed and which is configured to enable gas or liquid transport between the inside and the outside of the container when the insert is partially closed. Accordingly, partially closed and fully closed in the context of an insert are to be understood in analogy to the above. Preferably, a lid hinge connects lid and insert. Moreover, as described herein for the configured lid/sample tube a variety of configurations are possible for the insert as well. Hence, the analogous configurations are part of the present invention. For example, not the insert but the container can be configured with a kerf as described below. Particular useful are such lid-in-lids for the robot-assisted isolation of DNA. Since the lid may interfere with an arm of the robot, containers without lids are commonly used. The containers are afterwards closed with a screw cap which is rather time-consuming and cumbersome. The lid-in-lid can be quickly plugged into the container which is even feasible automatically. Furthermore, the lid-in-lid can be used for drying a sample as described below.

The lid according to the invention can be used for sample tubes having different shapes and sizes and are not meant to be limited to the sample tube of the examples.

The invention further encompasses a sample tube comprising a container having an opening and the above lid. Preferably, the sample tube is made of glass, more preferably of plastic. Typically, the sample tubes are tapered, conical or rounded, and closed at one end. For a tight seal and secure seating the outer diameter of the sealing lip is between 0.05 and 0.3 mm bigger, preferably between 0.05 and 0.15 mm bigger than the inner diameter of the opening.

In one embodiment, the inventive sample tube further comprises a lid hinge linking container and lid. The lid hinge is preferably located on the opposite edge of the lid extension and is flexible to allow an effortless opening and closing. Opposite of the lid hinge is preferably suited the configuration of the sealing lip and/or the plug. The configured part of the sealing lip and/or of the plug and the lid hinge are located on opposite sides.

A further object of the present invention is a so-called lid-in-lid closure as shown in FIG. 8. Said closure comprises an insert having a top opening and a bottom opening, and a circumferential sealing lip around said insert, wherein the sealing lip is sized and shaped to positively fit into the opening of a container of the sample tube, wherein the sealing lip and/or the insert is sized and shaped to seal between insert and container when the closure is fully plugged in and wherein the sealing lip and/or the insert is configured to enable gas or liquid transport between the inside and the outside of the container when the closure is partially plugged in.

The closure preferably further comprises a snap-on lid, wherein the snap-on lid is sized and shaped to positively fit into the top opening of the insert. A lid hinge linking insert and snap-on lid is also preferred.

In a particular embodiment the closure comprises an insert, a lid and a lid hinge. A sealing lip of the insert is located around the plug of the insert. The sealing lip is configured to allow ventilation when the insert is plugged into a sample tube in partially closed position. When the insert is completely plugged into a container (i.e. fully closed), the sealing lip effectively seals between insert and container. A conventional lid having an unconfigured annular sealing lip around its plug is attached to the insert via a lid hinge.

In analogy to the above the following embodiments are claimed:

The configured part of the sealing lip corresponds to the configured part of the insert in size, shape and/or position.

The configuration is a deformation, constriction, recess or opening of a part of the sealing lip and/or a recess or opening of the plug.

The deformed or constricted part of the sealing lip extends towards the top of the insert.

The deformed or constricted part of the sealing lip is U- or V-shaped.

A shield extends downwardly from the top of the snap-on lid or insert to block the penetration of contaminants through the recess of the sealing lip and/or the insert.

A plurality of closures are connected to each other in a pattern to allow the closure of a strip of sample tubes or a plate of sample tubes.

This closure can be part of a sample tube. Accordingly, a sample tube comprising a container having an opening and the above closure is disclosed.

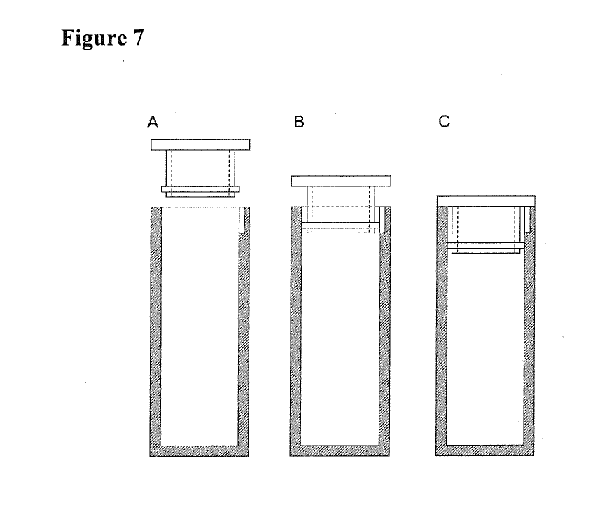

Furthermore, some sample tubes are designed to seal the container with the top of the lid (e.g. PrepFiler™ Spin Columns, Life Technologies). These tubes lack a tight sealing such that leakage is prevented, i.e. applicant observed that liquid leaks through the sealing when the column is placed upside down. This drawback is overcome by the following embodiment which relates to a container having a opening, wherein the inner wall surface of the container is configured to enable gas and liquid transport between the inside and the outside of the container if a conventional, i.e. not configured, lid is placed onto said container in partially closed position. Partially closed and fully closed is to be understood in analogy to the above definition with the difference that the gap is formed on part of the inner wall surface of the container. The configuration within the context of a container is for example a deepening such as a kerf in the container extending toward the vertical axis in the direction of and ending at the top of the container as shown in FIG. 7. When the lid is partially closed the sealing lip is on a level with the kerf thereby creating an air gap between the sealing lip of the lid and the container (FIG. 7B) whereas the sealing lip is below the kerf in the fully closed position which confers tight sealing. The skilled person will readily appreciate that a wide (in radial direction) deepening gives good ventilation on the cost of smaller friction in partially closed position. Accordingly, a container for a sample tube having an opening at one end is disclosed, wherein the container is configured to enable gas or liquid transport between the inside and the outside of the container when the sample tube is partially closed and wherein the container is sized and shaped to seal the sample tube when the insert is fully closed. This container has preferably a recess extending towards the top of the container.

The invention also embraces a method for drying a sample comprising the steps of (a) providing the inventive lid and a container having an opening, or the inventive sample tube, or the inventive closure or the inventive container (b) plugging the lid/closure into the opening of the container of the sample tube into partially closed position which enables gas transport between the inside and the outside, and (c) incubating the sample for appropriate time and under appropriate conditions.

The lid, sample tube, closure or container described herein is particularly useful for drying a sample within a partially closed sample tube and subsequently storing said sample in a fully closed sample tube. Hence, the invention also relates to the use of the inventive lid, sample tube, closure or container for storing or drying a sample—without or with a lower risk of contamination than current used sample tubes.

The invention also relates to a sample tube comprising
(a) a container having an opening and
(b) a lid according to the invention and a closure according to the invention,
wherein the lid is attached to the container with a junction or also hinge as used as well herein.

Preferably the sample tube herein is a microcentrifuge tube with a lid or cap. Preferably the range of volumes is between about 2 ml and 100 microliters; see for example FIG. 1.

### EXAMPLES

2 mm thick round disks were cut out of a sponge rubber. They had a diameter of 7.1 mm.

Incubation was done with lid less spin-baskets. The inner diameter was 7 mm.

The rubber discs were inserted into the spin-baskets. An O-ring was used to fix the rubber discs.

The baskets were water tightly sealed due to the discs.

Now the baskets were placed into 2 ml centrifuge tubes. The lid was closed.

The inventive effect, i.e. the release of access air was shown by using standard 2 ml centrifuge tubes with a standard lid and the inventive tubes with the new lid.

An amount of 500 μl water had been placed in each tube (basket). The tubes were left to rest on the laboratory bench for various time spans. A total of 10 tubes with the new lid and 10 tubes with the standard lid were tested.

The amount of water was measured that was found in the receiver tube. As can be seen, the pressure exerted by the standard lid results in large water leaks towards the receiver tube. In contrast the inventive lid and tube losses no water.

TABLE 1

standard lid

| | | | | |
|---|---|---|---|---|
| Incubation time ( h) | 1 h | 2 h | 6 h | 24 h |

amount of liquid in the receiver tube (μl)

| | | | | |
|---|---|---|---|---|
| Tube 1 | 200 | 450 | 500 | 500 |
| Tube 2 | 200 | 350 | 500 | 500 |
| Tube 3 | 200 | 300 | 400 | 500 |
| Tube 4 | 100 | 150 | 300 | 450 |
| Tube 5 | 150 | 250 | 500 | 500 |
| Tube 6 | 75 | 150 | 300 | 450 |
| Tube 7 | 150 | 250 | 300 | 500 |
| Tube 8 | 250 | 450 | 500 | 500 |
| Tube 9 | 200 | 300 | 350 | 500 |
| Tube 10 | 200 | 350 | 500 | 500 |

| modified lid, according to FIG. 1 | | | |
|---|---|---|---|
| 1 h | 2 h | 6 h | 24 h |

amount of liquid in the receiver tube (μl)

| | | | | |
|---|---|---|---|---|
| Tube 1 | 0 | 0 | 0 | 0 |
| Tube 2 | 0 | 0 | 0 | 0 |
| Tube 3 | 0 | 0 | 0 | 0 |
| Tube 4 | 0 | 0 | 0 | 0 |
| Tube 5 | 0 | 0 | 0 | 0 |
| Tube 6 | 0 | 0 | 0 | 0 |
| Tube 7 | 0 | 0 | 0 | 0 |
| Tube 8 | 0 | 0 | 0 | 0 |
| Tube 9 | 0 | 0 | 0 | 0 |
| Tube 10 | 0 | 0 | 0 | 0 |

1. A lid for a sample tube comprising:
a) a lid top,
b) a plug extending downwardly from said lid top, and
c) a circumferential sealing lip around said plug,
wherein the sealing lip is sized and shaped to positively fit into the opening of a container of the sample tube, wherein the sealing lip is sized and shaped to seal the container via a circumferential uninterrupted contact of the sealing lip and the container when the lid is fully closed and wherein the sealing lip has a configuration to enable gas or liquid transport between the inside and the outside of the container via an air gap between the lid and the container when the lid is partially closed, wherein partially closed denotes a penetration depth of the plug into the container between 0.5 mm and 0.5 mm less than the maximum penetration depth.

2. The lid according to claim 1, wherein the plug is configured to enable gas or liquid transport between the inside and the outside of the container when the lid is partially closed and wherein the configuration of the sealing lip corresponds to the configured part of the plug in size, shape and/or position.

3. The lid according to claim 1, wherein the configuration is a deformation, constriction, recess or opening of a part of the sealing lip.

4. A closure for a sample tube comprising:
a) an insert having a top opening and a bottom opening, and
b) a circumferential sealing lip around said insert,
wherein the sealing lip is sized and shaped to positively fit into the opening of a container of the sample tube, wherein the sealing lip is sized and shaped to seal between insert and container via a circumferential uninterrupted contact of the sealing lip and the container when the closure is fully plugged in and wherein the sealing lip has a configuration to enable gas or liquid transport between the inside and the outside of the container via an air gap between the insert and the container when the closure is partially plugged in, wherein partially plugged in denotes a penetration depth of the insert into the container between 0.5 mm and 0.5 mm less than the maximum penetration depth.

5. The closure according to claim 4 further comprising a snap-on lid, wherein the snap-on lid is sized and shaped to positively fit into the top opening of the insert.

6. The closure according to claim 5 further comprising a lid hinge linking insert and snap-on lid.

7. The closure according to claim 4, wherein the insert is configured to enable gas or liquid transport between the inside and the outside of the container when the closure is partially plugged in and wherein the configuration of the sealing lip corresponds to the configured part of the insert in size, shape and/or position.

8. The closure according to claim 4, wherein the configuration is a deformation, constriction, recess or opening of a part of the sealing lip.

9. A plurality of lids according to claim 1, wherein said lids are connected to each other in a pattern to allow the closure of a strip of sample tubes or plate of sample tubes.

10. A sample tube comprising:
a) a container having an opening and
b) a lid according to claim 1,
c) a lid hinge linking container and lid, wherein the sample tube is a microcentrifuge tube with a volume between about 100 microliters and 2 ml.

11. The sample tube according to claim 10, wherein the outer diameter of the sealing lip is between 0.5 and 0.3 mm bigger than the inner diameter of the opening.

12. The sample tube according to claim 10, wherein the configured part of the sealing lip and the lid hinge are located on opposite sides.

13. A container for sample tube having an opening at one end, wherein the inner wall surface of the container is configured to enable gas or liquid transport between the inside and the outside of the container via a gap formed on part of the inner wall surface of the container when the sample tube is partially closed by a lid and wherein the container is sized and shaped to seal the sample tube when the container is fully closed by a lid, wherein partially closed denotes a penetration depth of the lid into the container between 0.5 mm and 0.5 mm less than the maximum penetration depth.

14. A method of drying a sample comprising the steps of:
a) providing a lid according to claim 1 and a container having an opening,
b) plugging the lid closure into the opening of the container of the sample tube into a partially closed position which enables gas transport between the inside and the outside, and
c) incubating the sample for appropriate time and under appropriate conditions.

15. (canceled)

16. A plurality of closures according to claim 4, wherein said closures are connected to each other in a pattern to allow the closure of a strip of sample tubes or plate of sample tubes.

17. The sample tube according to claim 10, wherein the outer diameter of the sealing lip is between 0.05 and 0.15 mm bigger than the inner diameter of the opening.

18. A method of drying a sample comprising the steps of:
a) providing a closure according to claim 4 and a container having an opening;
b) plugging the closure into the opening of the container of the sample tube into a partially closed position which enables gas transport between the inside and the outside; and
c) incubating the sample for appropriate time and under appropriate conditions.
